(19) United States
(12) Patent Application Publication
(10) Pub. No.: US 2009/0203269 A1
(43) Pub. Date: Aug. 13, 2009

(54) PROXIMITY SWITCH AND METHOD FOR CONTACTING A SENSOR PCB

(75) Inventors: Bernd Jenne, Konstanz (DE); Burkhard Reetmeyer, Konstanz (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: BAUMER ELECTRIC AG, Frauenfeld (CH)

(21) Appl. No.: 12/299,681

(22) PCT Filed: May 4, 2007
(86) PCT No.: PCT/CH2007/000226

§ 371 Date: Nov. 5, 2008

(30) Foreign Application Priority Data
May 12, 2006 (CH) 780/06

(51) Int. Cl. H01R 4/48

(52) U.S. Cl. 439/862

(57) ABSTRACT

A proximity sensor (1) including a PCB (10) which contains the sensor electronics, a sensor element and a sensor interface. The electric connections between the PCB (10) and the sensor interface and/or the sensor element are established by plug-in contacts. Preferably, contact elements (21) having bifurcated arms (25) and contact blades (27) are configured on the sensor housing, and the PCB (10) is inserted between the bifurcated arms (25) in such a way that the contact blades (27) establish an electrical connection with contact surfaces (53) on the PCB (10).

### BACKGROUND

The subject matter of the invention is a proximity switch and a method for contacting a sensor printed circuit board according to the features of Claims 1 and 6.

Proximity switches and distance sensors that detect the distance of objects by means of various physical principles and that generate a digital or analog electrical output signal as a function of the object distance often comprise a cylindrical or block-shaped housing made from metal or plastic. For cylindrical housings, threading is usually formed on the outer lateral surface for attaching the sensor to a machine part.

Inductive proximity switches and distance sensors usually comprise an oscillator with a coil inserted into a shell core made from ferrite, an evaluation stage, and an output amplifier. For cylindrical sensors, the coil is arranged in the region of one casing end, wherein the coil unit is usually covered by a cap made from plastic or ceramic arranged flush with the casing or projecting past the casing. In the housing interior there is a printed circuit board or PCB with the components necessary for controlling the oscillator and for evaluating the sensor measurement variable. The printed circuit board can be mounted on the shell core on the back side, e.g., by mechanical attachment means. For such known sensors, the ends of the coil wire are connected electrically by solder to contact surfaces on the printed circuit board. On the opposite end of the printed circuit board there are additional contact surfaces for soldering a connection plug or a cable. These surfaces form the interface of the sensor to the outside.

In the production of conventional sensors, the interior of the housing is encapsulated, e.g., from the connection side with a curing casting resin after the printed circuit board and the coil unit have been inserted into the casing and the closing cap has been set on the front side. Then the back-side closing plug is placed on the casing with the contacts guided outward. Obviously, slightly different methods for assembling such sensors are also known.

The production or the assembly of such conventional sensors is relatively complicated and expensive due to the solder connections required for contacting the sensor element and the sensor interface and due to the encapsulation with a casting resin.

### SUMMARY

The objective of the present invention is thus to create a sensor and a method for contacting a sensor printed circuit board that allow a simple and economical production of the sensor, in particular, an inductive proximity switch or distance sensor.

This objective is met by a proximity switch and by a method for contacting a printed circuit board according to the features of Claims 1 and 6. Advantageous constructions are described in the subordinate claims.

The invention is based on the idea of eliminating solder connections for the connection of sensor elements and/or contact elements for the sensor interface and using, instead of solder connections, solder-free connection means, such as spring and/or clamp contacts. In this way, the production process of the sensors can be significantly simplified. Contrary to the previous opinion of experts, sufficiently good electrical connections between the printed circuit board and sensor elements (e.g., coils) and/or between the printed circuit board and contact pins for connecting a connection plug or a connection cable can be established with suitable spring and clamp contacts. Such solder-free connections are functional even under harsh conditions of use and are suitable, in particular, for the production of sensors in which the housing with the electronics is not encapsulated with a curing casting resin as was typical before.

Advantageously, the contacting of the sensor printed circuit board according to the invention is used for sensors with a housing casing produced using injection-molding technology.

Such sensors can comprise, e.g., a housing with an outer, usually metallic housing casing and an inner casing made from plastic injection molded onto the inside of the outer casing. The housing advantageously has a cylindrical or cylinder-like shape with a round housing cross section and with or alternatively without an outer threading on the outer casing. Alternatively, the housing can also have a square, rectangular, or an arbitrarily different cross-sectional form. In particular, the housing can have different cross-sectional surfaces at different positions in the axial direction given by the housing casing. The injection-molded inner casing made from plastic acts as an electrical isolator between the sensor electronics arranged on a printed circuit board in the interior of the housing and the outer housing casing. Guides formed on the inside of the inner casing allow a simple and guided insertion of a printed circuit board equipped with electronic components into the housing and then hold these in the provided position. Longitudinal or transverse grooves, boreholes, or other structures formed on the inside of the outer housing casing guarantee that the inner housing casing and the outer housing casing cannot move relative to each other, not even if the adhesive connection between the injection-molded plastic casing and the outer casing or the outer housing casing should become loose. In particular, for example, for cylindrical housings, rotational locking and displacement locking of the two housing casings can be guaranteed. A separating wall or a base that divides the interior of the housing into a front sub-space and a rear sub-space is formed on the inner casing. The front sub-space is designed for holding the electronics with the sensor element or elements. The rear, usually significantly shorter sub-space is constructed as a plug receptacle for connecting a connection cable via plug-in connectors. In the production process, that is, when plastic is injected into the injection-molding die provided for this purpose, contact elements according to the invention are encased in the base or set partially in plastic using injection molding. The contact elements project past the base on both sides. Advantageously, the contact elements are all equal and shaped as bent stamped parts. For connecting a plug, contact pins of the contact elements project backward from the base. The positions of the contact pins correspond to the positions of the corresponding contact springs of the desired connection plug. The rear part of the inner housing casing is constructed in such a way that it corresponds to the provided connection plugs. In particular, e.g., in the rear region there can be ribs that project to the inside of the inner casing and that are used as reverse polarity protection when connecting a plug with corresponding grooves. The part of the contact elements projecting into the housing interior has a bifurcated construction with contact springs or contact blades. The contact elements are arranged in such a way that the contact arms projecting axially into the housing interior lie in a row. When a printed circuit board equipped with components is inserted, the board is clamped tight between the bifurcated arms, with the contact springs or blades establishing solder-free electrical connections with corresponding contact surfaces or pads on the printed circuit board. The production of a sensor with contacting of the printed circuit board according to the invention is very simple. The electronic printed circuit board is inserted into the housing along the guides on the inner wall of the housing until its rear end is clamped tight between the contact arms and the electrical connection of the contact elements is established with the pads on the printed circuit board. In the region of the front edge of the printed circuit board, a closing cap made from plastic is connected to the printed circuit board or placed on this printed circuit board. The closing cap is advantageously constructed so that it can be used as a carrier for the sensor element or elements—for example, a coil with a ferrite core—so that these are arranged as close as possible to the front end of the sensor housing. Alternatively, the closing cap and coil carrier can also be constructed as separate parts and mounted in some other way on the printed circuit board or housing. The electrical connection of the sensor elements with the printed circuit board can be realized, e.g., by soldering or bonding connection wires or without solder according to the invention by use of plug-in connections.

After inserting the printed circuit board into the housing, the closing cap or the closing cover is connected to the front-side end of the inner casing in the edge region, e.g., through laser welding, ultrasonic welding, or adhesion. Therefore, the front sub-space of the housing is closed tight. In contrast to conventionally manufactured sensors, encapsulation of the housing interior with a curing casting mass is not required, but it is nevertheless possible if necessary. Obviously, in this case additional means, such as, e.g., elastic sealing lips could be provided that prevent or make more difficult the direct contact of the casting resin with the contact elements and thus prevent the interruption of solder-free contacts by the curing casting resin. Alternatively or additionally, blade contacts can be provided that cut or press or mark corresponding contact surfaces and thus prevent contact interruption by casting resin.

### BRIEF DESCRIPTION OF THE DRAWINGS

With reference to the figures, the invention is described in more detail below with the example of cylindrical inductive proximity switches. Shown herein are:

FIG. 1 a longitudinal section view of a first inductive proximity switch,

FIG. 2 two views of a contact element,

FIG. 3 a perspective view of a closing cover,

FIG. 3a a perspective view of another closing cover with connection pins,

FIG. 4 an exploded view of another inductive proximity switch,

FIG. 5 a view of a coil carrier of the proximity switch from FIG. 4,

FIG. 6 a first longitudinal section view of the proximity switch from FIG. 4,

FIG. 7 a second longitudinal section view of the proximity switch from FIG. 4 in the plane of the printed circuit board.

### DETAILED DESCRIPTION OF THE PREFERRED EMBODIMENTS

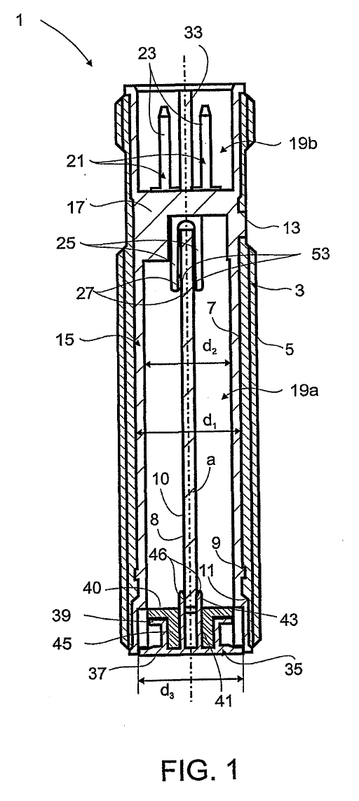

FIG. 1 shows a longitudinal section through a first inductive proximity switch 1 with a cylindrical, outer housing casing 3 made from metal, also called metal casing or casing. The housing axis α is shown by a dash-dot line. The front region of the metal casing comprises an outer thread 5 for the mounting of the sensor at its determined position, for example, on a machine part. On the inner wall 7 of the outer housing casing 3 there are radial peripheral indentations or grooves 9 and projections 11, so that the casing has different cross sections or inner diameters d₁ as a function of the axial position. In addition, in the rear region a borehole 13 or another recess penetrating the outer housing casing 3 is formed. An inner housing casing 15 made from plastic is injection molded on the inner wall 7 of the outer housing casing 3. The plastic advantageously fills the borehole 13 completely and closes flush with the outside of the outer housing casing 3. The structures on the inner wall 7 of the outer housing casing prevent relative movement between the two housing casings 3, 15 even if the adhesion connection generated by the injection-molding process should become loose between the casings 3, 15. If a transparent plastic is used for the inner housing casing 15 or at least for the part of the housing casing 15 in the region of the boreholes 13, a light-emitting diode or another optical display means and/or elements of an infrared communications interface can be arranged in the interior of the housing so that it is visible from the outside. On the inside of the inner housing casing 15, advantageously two diametrically opposed guide grooves 8 extending in the direction of the housing axis α are formed for the guided insertion and holding of a printed circuit board or a printed circuit board 10 equipped with electronic components. Alternatively, guide ribs or other guide elements projecting into the housing interior can also be formed on the inner housing casing 15. Advantageously, the inside of the inner housing casing 15 has a slightly conical or slightly tapered construction at least in the front region of the housing in the direction of the housing axis α in such a way that the inner diameter d₂ slightly increases toward the front-side housing end. Therefore, after injection molding of the inner housing casing 15, a corresponding insert of the injection-molding die can be easily pulled out from the casing. The front-side end of the inner housing casing 15 has a thin-walled construction with a projection or a shoulder 16 with larger inner diameter d₃ for receiving a shell core 45. An intermediate wall or a base 17 separates the space enclosed by the inner housing casing 15 into a front sub-space 19a and a rear sub-space 19b. According to the invention, several contact elements 21 are molded into the base 17 or set partially in plastic on the base 17 such that contact pins 23 for contacting a cable plug extend backward into the rear sub-space 19b. The part of each of the contact elements 21 projecting forward into the front sub-space 19a comprises two opposing spring contacts or contact blades 27 arranged on two bifurcated arms 25. In the example of the proximity switch 1 shown in FIG. 1, four equal contact elements 21 produced as bent stamped parts are arranged in a row, wherein, in the longitudinal section view shown, only two of the contact pins 23 and only the two bifurcated arms 25 of one of the contact elements 21 are visible.

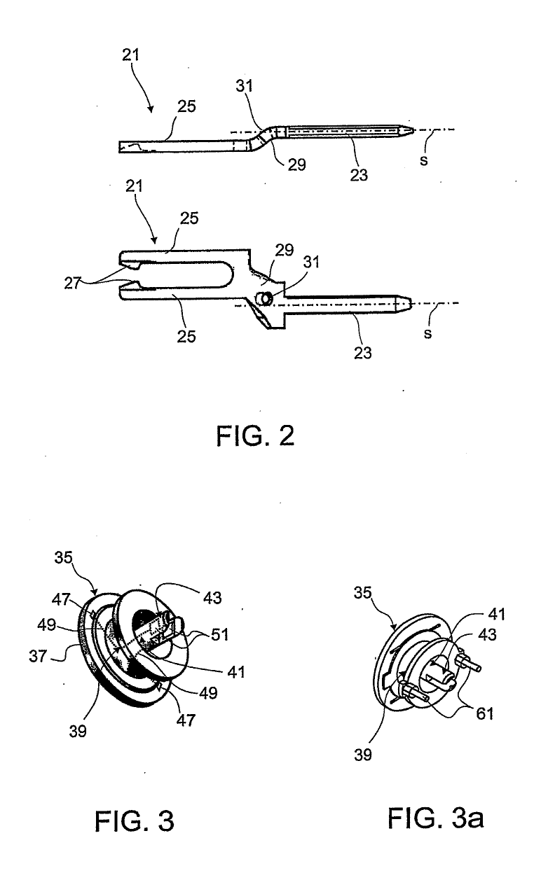

In FIG. 2, such a contact element is shown in a top view (top) and in a side view (bottom). The pin axis s of the contact pins 23 lies below the bifurcated arms 25 and—due to the bending in the middle region 29 of the stamped part—also laterally offset to these bifurcated arms 25. Four equal stamped parts of this type can be constructed in the front sub-space 19a as a printed circuit board receptacle with four bifurcated arms 25 arranged one next to the other and in the rear sub-space 19b as contact pins 23 arranged at the corners of a square or rectangle for connecting to a connection plug.

A recess 31 in the middle region 29 of the contact elements 21 is filled by plastic during the injection molding with the plastic mass and is used for stabilizing and for absorbing forces during the contacting or during the separation of a connection plug. In the region of the rear sub-space 19b there is a guide rib 33 projecting inward on the inner housing casing 15 and running in the direction of the housing axis α. It is used as reverse polarity protection and as a guide during the connection of a connection plug provided with a corresponding groove.

FIG. 3 shows closing cover or a cap 35 made from plastic in a first configuration. It comprises a round front plate 37, a flange-like coil carrier 39 formed concentric on this front plate, and a cylindrical, centrally arranged holding pin 41 with a bifurcated end 43 for receiving and clamping tight a printed circuit board 10. The cap 35 is constructed so that a pot-shaped ferrite shell core 45 with an E-shaped cross section and a central borehole can be pushed or placed on the holding pin 41 in such a way that it surrounds a coil (not shown) wound onto the coil carrier 39 on three sides like a channel or toroid (FIG. 1). Here, the rear end 43 of the central holding pin 41 projects past the base surface 40 of the shell core 45. The front end of the rectangular printed circuit board 10 is clamped tight in the bifurcated recess on the holding pin 41. The free ends of the coil wire wound onto the coil carrier 39 can be connected, e.g., directly with corresponding contact positions 46 on the printed circuit board 10, e.g., by solder. Alternatively, the ends of the coil wire can also be connected according to the invention indirectly to contact points on the printed circuit board 10. They can be connected in an electrically conductive way, e.g., by laser soldering or bonding to metallization positions 47 (FIG. 3) formed on the cap 35. These metallization positions 47 are connected, in turn, e.g., by connection wires or conductor tracks 49 set or molded into the coil carrier 39 to other contact elements, for example, to other metallization positions 51 formed on the insides of the bifurcated end 43 of the holding pin 41. The contact positions 46 on the printed circuit board 10 are arranged so that when the cap 35 is placed on the printed circuit board 10, a solder-free electrical connection is established between the metallization positions 51 on the holding pin 41 or the coil and the contact positions 46 on the printed circuit board 10. The coil or, in general, the sensor element, is thus connected electrically to the sensor electronics.

For another construction of the cap 35 according to FIG. 3a, two connection pins or contact pins 61 on the coil carrier 39 project backward. These can be soldered tight either directly to corresponding contact positions 46 on the printed circuit board 10 or inserted into corresponding plug-in sockets (not shown) on the printed circuit board 10. After the connection between the coil and the printed circuit board 10 has been established, the printed circuit board 10 can be inserted together with the cap 35 from the front along the guides 8 into the housing until it is clamped tight in the region of its rear end between the bifurcated arms 25 of the contact elements 21 and the contact blades 27 have contacted on one or both sides corresponding pads or contact surfaces 53 formed on the printed circuit board 10.

In the first construction of the sensor according to FIG. 1, when the printed circuit board 10 is inserted, the shell core 45 is led into contact with the shoulder 16 or the projection of the inner housing casing 15 with a thin-walled construction on the front side. In this position, the front end of the inner housing casing 15 and the edge of the front plate 37 are connected tightly to each other, for example, by laser welding, ultrasonic welding, or adhesion.

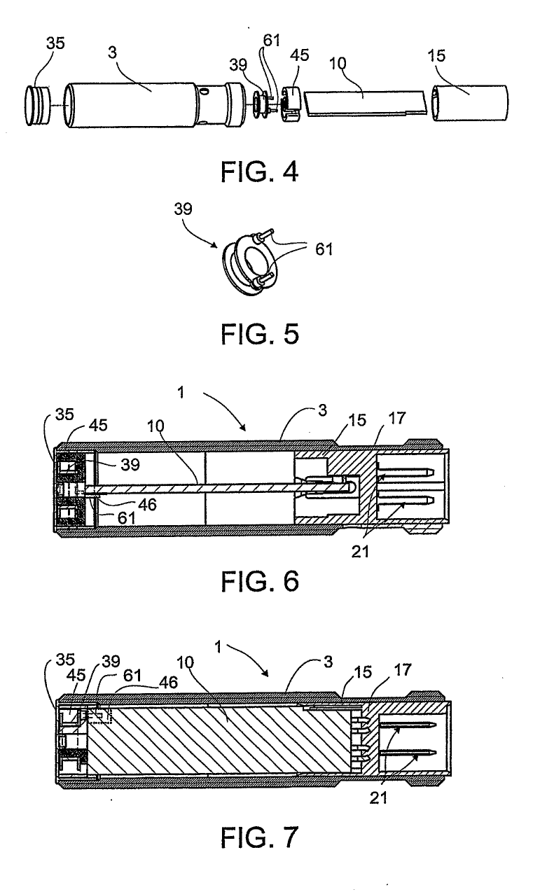

In another configuration of the distance sensor or proximity switch 1, as shown in FIGS. 4, 5, 6, and 7, the coil carrier 39 and the cap 35 are constructed as standalone parts. Instead of the metallization positions 51, other contact elements are constructed, such as, e.g., contact pins 61 projecting backward on the coil carrier 39 or alternative contact springs or contact blades that are connected to corresponding contact elements on the printed circuit board 10, for example, with connection surfaces or contact positions 46 or with plug-in sockets (not shown) on the printed circuit board 10. According to the construction of the pins 61 or contact elements, the connections can be realized with contact elements on the printed circuit board 10 by thermal connection methods or without solder. In this configuration of the invention, the inner housing casing 15 can be constructed as a separate plug that is significantly shorter than the outer housing casing 15 and that is inserted or pressed from the rear-side opening into the rear region of the outer housing casing 3.

The cap 35 has a nozzle-like construction, wherein the peripheral end 55 is inserted or pressed into the gap between the shell core 45 and the outer housing casing 3. For sealing the cap 35 and the inner housing casing 15 relative to the outer housing casing 3, sealing elements, such as, e.g., O-rings, can be provided (not shown). The non-positive fit connections between the cap 35 or the inner housing casing 15 and the outer housing casing 3 can also be secured by latch means (not shown). In the example shown in FIGS. 4 to 7, the contact pins 61 are soldered tight at corresponding contact positions 46 or pads on both sides of the printed circuit board 10.

The idea forming the basis of the invention comprises all possible combinations in which the printed circuit board 10 of a distance sensor or proximity switch 1 is connected by plug-in contacts to a connection interface allocated to the sensor or proximity switch 1 (e.g., contact pins 23 for a connection plug or for connecting a cable) and/or a sensor element (e.g., coil) allocated to the distance sensor or proximity switch 1. The connections can be constructed arbitrarily by use of plug-in contacts and couplings or by contact springs or contact blades that are pressed against metallized contact elements.

1. Proximity switch (1) comprising a casing-like housing, a printed circuit board (10) arranged therein with sensor electronics, at least one sensor element, and a sensor interface, and electrically conductive connections are established between at least one of the printed circuit board (10) and the sensor interface or the printed circuit board (10) and the sensor element as plug-in contacts.

2. Proximity switch (1) according to claim 1, wherein contact elements (21) with contact springs or contact blades (27) that are connected electrically to corresponding contact surfaces (53) on the printed circuit board (10) are formed on the housing or on a part of the housing.

3. Proximity switch (1) according to claim 2, wherein the contact elements (21) comprise two opposing bifurcated arms (25) and the printed circuit board (10) is clamped tight between the bifurcated arms (25).

4. Proximity switch (1) according to claim 3, wherein the contact elements (21) are constructed as crimped stamped parts and comprise contact pins (23), wherein the pin axes (s) of the contact pins (23) are offset relative to the bifurcated arms (25).

5. Proximity switch (1) according to claim 4, wherein a plurality of the contact elements (21) are set in a base (17) of the housing produced as an injection-molded part in such a way that the bifurcated arms (25) for holding one end of the printed circuit board project into a front sub-space (19a) of the housing and the contact pins (23) project as contact elements of a sensor interface into a rear sub-space (19b) of the housing.

6. Method for contacting a printed circuit board (10) for a proximity switch (1) with at least one of a sensor interface or a sensor element of the proximity switch (1), wherein the proximity switch (1) comprises a casing-like housing, the method comprising connecting at least one of the sensor interface or the sensor element to the printed circuit board (10) by plug-in contacts.

7. Method according to claim 6, further comprising forming metallized contact surfaces (53) on the printed circuit board (10) and wherein the plug-in contacts are formed as contact elements (21) arranged in a row with contact blades (27) arranged on bifurcated arms (25), and inserting the printed circuit board (10) between the bifurcated arms (25) and clamping the printed circuit board between the bifurcated arms (25) with the contact blades (27), and establishing an electrical connection between several of the contact blades (27) and correspondingly arranged contact surfaces (53) on the printed circuit board (10).
